(19) United States
(12) Patent Application Publication
(10) Pub. No.: US 2005/0153596 A1
(43) Pub. Date: Jul. 14, 2005

(54) POWER TOOL BATTERY CONNECTOR

(76) Inventors: Weston VanWambeke, Cockeysville, MD (US); Christopher J. Murray, Baltimore, MD (US); Vincent P. Cooper, Baltimore, MD (US)

Correspondence Address: HARNESS, DICKEY & PIERCE, P.L.C., P.O. BOX 828, BLOOMFIELD HILLS, MI, 48303, US

(21) Appl. No.: 10/756,612

(22) Filed: Jan. 13, 2004

(51) Int. Cl. H01R 3/00

(52) U.S. Cl. 439/500

(57) ABSTRACT

A power tool electrical connector has a first and second connector connected with one another via an electrical cord. The first connector has a base with a configuration that mates with a battery cavity of a power tool in substantially the same way as the power tool's battery is received in the power tool. An electrical connector on the base electrically mates with the electrical connector in the cavity. The second connector has a base with a configuration that receives the power tool's battery in substantially the same way as the power tool's battery is received in the power tool. Also, the second connector includes an electrical connector to electrically couple with the battery.

### BACKGROUND AND SUMMARY OF THE INVENTION

The present invention relates to power tools and, more particularly, to a connector which enables the power tool battery to be placed at a position auxiliary to the power tool.

With the advent of battery operated power tools, designers have sought to provide the tools with more power. In order to increase the power to the tool, ordinarily batteries have become larger. As the batteries have become larger, the batteries have become heavier. Thus, the power tools in use can become somewhat heavy for the user and create an inconvenience.

Several types of devices have been created to overcome this dilemma. One type of device is a clothing type of article which is worn by the user. The clothing article includes batteries which are electrically coupled with the power tool. Other types of devices include belts supporting batteries that wrap around the user and have a device to couple with the power tool. Some of these devices enable coupling with the battery while others enable coupling directly with the power tool. However, the devices utilize auxiliary batteries which are different from the battery that is directly coupled with the power tool.

The present invention provides an electrical connector which enables the power tool battery to be used at a position auxiliary to the power tool. The present invention provides an electrical connector which couples with the power tool and the power tool battery while the power tool battery is secured to the user. The present invention enables the power tool to be lighter and to utilize its own battery.

In accordance with a first aspect of the present invention, a power tool battery connector comprises a first connector having a base and an electrical connection member. The base has a male configuration such that the base mates with a battery cavity in a power tool substantially the same way as a battery, designed for the power tool, is received in the power tool. The electrical connector member couples with an electrical connector in the battery cavity. A second connector includes a base and an electrical connector member. The base has a female configuration such that the base receives the battery in substantially the same way as the cavity of the power tool receives the battery. The electrical connector member is electrically coupled with the battery. Also, a cord is present to electrically connect the first and second connectors with one another. The second connector includes a member, such as a hook to connect with a belt of the user. The first connector base includes a rail assembly to connect with a rail assembly in the battery cavity. The second connector base includes a rail assembly to receive a rail assembly of the battery.

In accordance with a second aspect of the invention, a power tool having a battery receiving cavity includes a connector assembly. The connector assembly comprises a first connector having a base and an electrical connection member. The base has a male configuration such that the base mates with a battery cavity in a power tool substantially the same way as a battery, designed for the power tool, is received in the power tool. The electrical connector member couples with an electrical connector in the battery cavity. A second connector includes a base and an electrical connector member. The base has a female configuration such that the base receives the battery in substantially the same way as the cavity of the power tool receives the battery. The electrical connector member is electrically coupled with the battery. Also, a cord is present to electrically connect the first and second connectors with one another. The connector assembly includes a member, such as a hook to connect with a belt of the user. The first connector base includes a rail assembly to connect with a rail assembly in the battery cavity. The second connector base includes a rail assembly to receive a rail assembly of the battery.

Other objects and advantages of the present invention will become apparent to those skilled in the art from a reading of the specification in combination with the drawings.

### BRIEF DESCRIPTION OF THE DRAWINGS

FIG. 1 is a perspective view of a power tool including the battery connector of the present invention.

FIG. 2 is an elevational view of the battery connector in accordance with the present invention.

FIG. 3 is a perspective view of the battery cavity of the power tool.

FIG. 4 is a perspective view of a battery pack in accordance with the present invention.

### DETAILED DESCRIPTION OF THE PREFERRED EMBODIMENTS

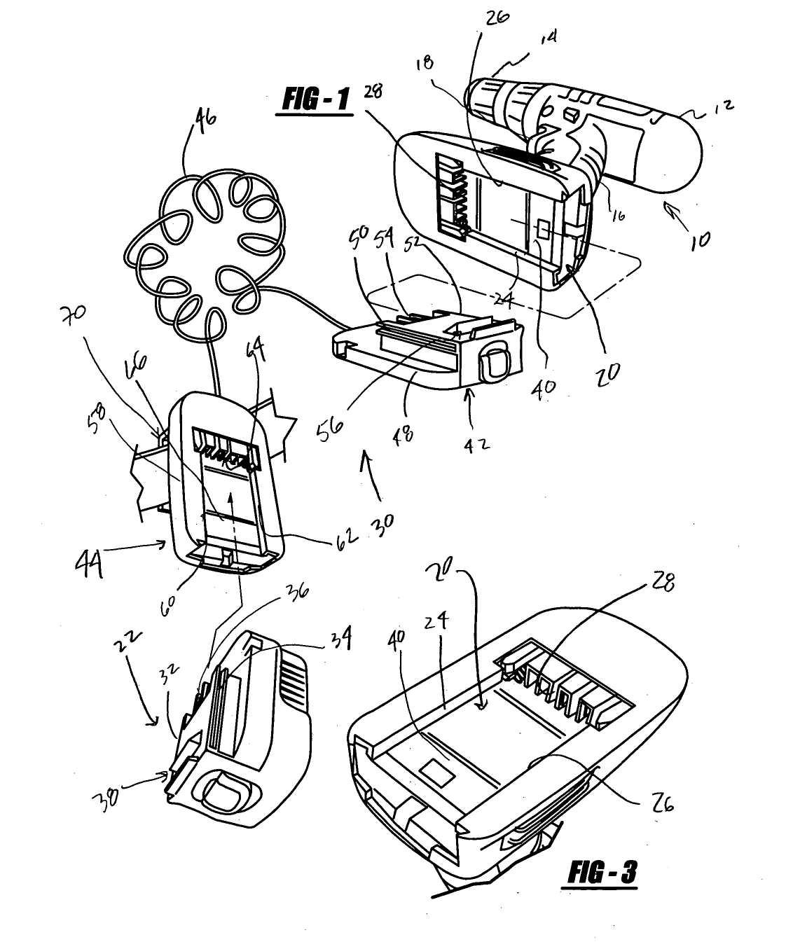

Turning to FIG. 1, a power tool is illustrated and designated with the reference numeral 10. A drill is shown, however, any battery operated power tool may be utilized. The power tool 10 includes a housing 12 which houses a motor (not shown) which is coupled with an output 14 for driving a tool. The tool housing 12 includes a handle portion 16 which includes an activation member 18 which is electrically coupled with a power source and the output. The housing 12 also includes a battery receiving cavity 20. A battery connector 30 is illustrated to be coupled with the power tool 10 and the power tool battery 22.

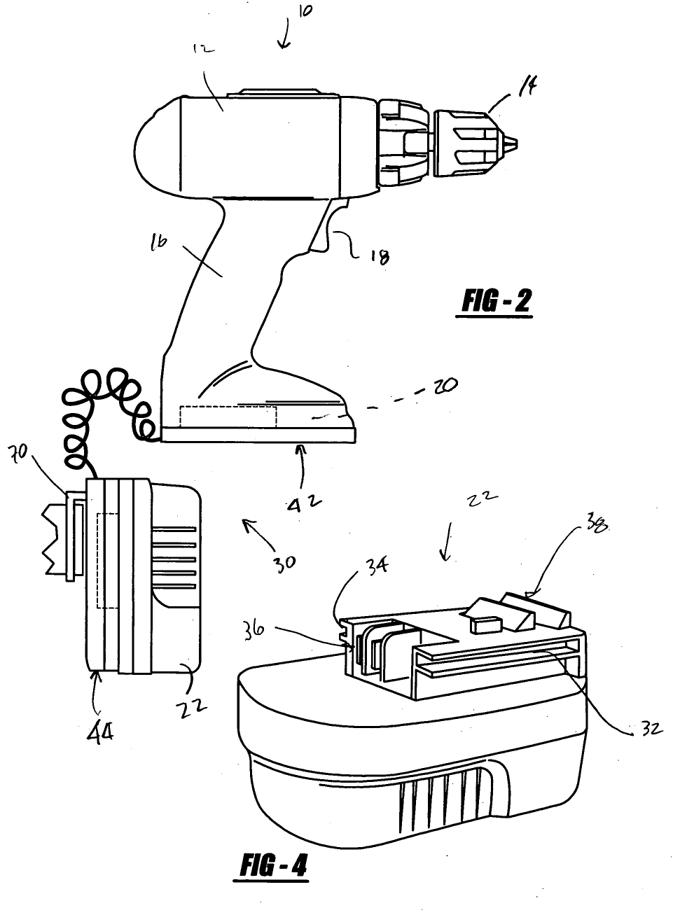

Turning to FIG. 3, the battery receiving cavity 20 is better shown. Here, the battery receiving cavity 20 includes rail receiving members 24 and 26, as well as an electrical connector 28. Also, the cavity includes an indention 30 to receive a locking member of the battery.

The battery 22 includes rail members 32 and 34, as well as an electrical connector member 36. Also, the battery 22 includes a locking member 38 to mate with indention 40. The rails 32 and 34 of the battery 22 mate with the rails 24 and 26 of the cavity 20. Thus, the battery is slidable into and out of the cavity 20 coupling and decoupling the two electrical contact member 26 and 36.

The electrical connector 30 includes a first electrical connector 42, a second electrical connector 44 and an electrical cord 46 to couple the two together. The first electrical connector 42 includes a base 48 which includes a pair of rails 50 and 52. Also, the base 48 includes an electrical connector member 54. The base 48 has an overall male configuration which is designed to fit into the battery cavity 20 in substantially the same way as the battery 22. The base 48 includes a locking member 56 for coupling with the indent 40 to retain the connector 42 within the battery cavity 20. Accordingly, the locking member 56 of the first connector 42 is substantially the same as the locking member 38 of the battery 22.

The second electrical connector 44 includes a base 58 with rails 60 and 62. Also, the base includes an electrical connector 64 to couple with the battery 22. The base 58, with the rail 60 and 62 formed as a female receiving cavity to receive the battery 22. The base 58 and rails 60, 62 have a configuration substantially the same as the battery receiving cavity 20 of the power tool 10. Thus, the battery 22 mates with the electrical connector 44 as if it is mating with the battery cavity 20. Also, the base 58 includes an indentation 66 to receive the battery locking member 38 to lock the two together.

The connector 44 also includes a member 70 to couple the second connector 44 with the user. Preferably, the connector is a hook or the like which would be secured with a belt or the pants of the user. Other types of securement members 70, such as hook and loop fasteners, pins and clutch fasteners, could be utilized to attach the connector 44 with the user.

Thus, the present invention enables the user to utilize the battery of the power tool at a position auxiliary to the power tool. This enables the power tool to be lighter while utilizing the power tool's own battery.

While the above detailed invention is subjected to alteration, modification and variation, those skilled in the art should recognize that such modifications are within the scope and spirit of the present invention.

1. A power tool battery connector comprising:
a first connector having a base and an electrical connection member, said base having a configuration such that said base mates with a battery cavity of a power tool in substantially the same way as a battery is received in the power tool, and said electrical connection member coupling with an electrical connector in said battery cavity;
a second connector having a base and an electrical connection member, said base having a configuration such that said base receives the power tool battery substantially the same way as the cavity in the power tool and said electrical connection member for electrically coupling with the battery; and
a member electrically connecting said first and second connectors with one another.

2. The connector according to claim 1, wherein said member connecting said first and second connectors being a cord.

3. The connector according to claim 1, wherein said second connector includes a member for connecting with a belt of a user.

4. The connector according to claim 1, wherein said first connector base includes a rail assembly for connecting with a rail assembly in said battery cavity.

5. The connector according to claim 1, wherein said second connector base includes a rail assembly for receiving a rail assembly of the battery.

6. A power tool comprising:
a power tool having a battery cavity;
a connector assembly, said connector assembly including a first connector having a base and an electrical connection member, said base having a configuration such that said base mates with a battery cavity of a power tool in substantially the same way as a battery is received in the power tool, and said electrical connection member coupling with an electrical connector in said battery cavity;
a second connector having a base and an electrical connection member;
a base and an electrical connection member, said base having a female configuration such that said base receives the power tool battery substantially the same way as the cavity in the power tool and said electrical connection member for electrically coupling with the battery; and
a member electrically connecting said first and second connectors with one another.

7. The connector according to claim 6, wherein said member connecting said first and second connectors being a cord.

8. The connector according to claim 6, wherein said second connector includes a member for connecting with a belt of a user.

9. The connector according to claim 6, wherein said first connector base includes a rail assembly for connecting with a rail assembly in said battery cavity.

10. The connector according to claim 6, wherein said second connector base includes a rail assembly for receiving a rail assembly of the battery.
